(19) United States
(12) Patent Application Publication
(10) Pub. No.: US 2023/0099611 A1
(43) Pub. Date: Mar. 30, 2023

(54) METHOD FOR REDUCING AN IMBALANCE OF A PROJECTILE SHELL

(71) Applicant: Rheinmetall Waffe Munition GmbH, Südheide (DE)

(72) Inventors: Thomas KADUR, Hermannsburg (DE); Matthias KUFFNER, Hermannsburg (DE); Hendrik RADIES, Hermannsburg (DE)

(21) Appl. No.: 18/073,848

(22) Filed: Dec. 2, 2022

Related U.S. Application Data
(63) Continuation of application No. PCT/EP2021/062322, filed on May 10, 2021.

(30) Foreign Application Priority Data
Jun. 4, 2020 (DE) 10 2020 114 842.9

(51) Int. Cl. G01M 1/12; F42B 30/08; F42B 33/00

(52) U.S. Cl. CPC G01M 1/122; F42B 30/08; F42B 33/001

(57) ABSTRACT

The invention relates to a method for reducing an imbalance of a projectile shell. The projectile shell has a body (1) which has a recess (4). By this recess (4), the body is provided with an inner wall (2) and an outer wall (3). In addition, a mouth hole (6) is provided, which is connected to the recess (4). A central axis (5) is now calculated from the outer geometrical shape of the projectile shell and a measurement is then performed to ascertain an imbalance of the projectile shell. On the basis of the measured imbalance, modified axis (8) is then calculated in relation to the central axis (5), and the body (1) is rotated about the modified axis (8) on the basis of the calculated modified axis (8). As the body (1) is rotated in this way, the projectile shell is machined to eliminate the imbalance as far as possible.

### FIELD

The present invention relates to a method for reducing an imbalance of a projectile shell. Corresponding projectile shells are required for projectiles in different calibers. In particular for medium and large caliber projectiles, the production is carried out by a forging process for various reasons.

### SUMMARY

Both the inner contour and the outer contour of the shell are defined by this forging process. A correct inner contour is necessary to be able to add an effective agent to the projectile.

The outer contour is conventionally finished by machining so that the required geometric tolerances are met. The outer contour thus has only small differences from the ideal required geometry.

The inner contour, on the other hand, can only be machined to a small extent near the mouth hole due to the technical circumstances. The mouth hole is intended to be able to insert the effective agent into the projectile, to close the projectile and, if necessary, to provide the projectile with a lifting device. Furthermore, the primer/fuse is often positioned in the mouth hole.

The machining in the small extent near the mouth hole can be caused by the fact that the mouth hole, for example, with a large shell length and small diameter, is relatively small and thus the inside of the projectile is difficult to access.

As a result, the inner contour has greater differences with respect to the ideal geometry of the projectile. In addition, the inner contour generally comprises a radial offset and an angular offset with respect to the machined outer contour. This leads to a static as well as a dynamic imbalance of the projectile shell.

These imbalance components increase the spread of the impact points in the target area. To reduce this spread, efforts are made to keep the imbalance as low as possible. For this reason, tolerances for imbalance are prescribed on the manufacturing drawing of the shell. In order to maintain these tolerances, certain steps are taken in the current manufacturing process.

During final turning of the outer contour, for example, the projectiles are clamped off-center by underlay plates and over-turned in order to slightly compensate for different wall thicknesses and the resulting imbalances. Furthermore, the shells are machined by a manual grinding process on the inside of the projectile in the area of the entire shell.

Material is thereby only removed at one position and not distributed over the surface of the inner contour. However, this correction method is affected by the subjective influences of the workers. Thus, the choice of eccentric splitting is made empirically from the measured imbalance. Grinding out at a specific point in the inner contour is done by hand and is subject to the subjective assessment of the worker. Between grinding processes, multiple weighing is necessary to control the specified mass to be removed. A slight difference from the specified angle can ruin the result and render the shell unusable. Reworking is not possible as it would result in the shell being underweight.

Thus, the known procedure is not process-safe and depends heavily on the experience of the worker. Furthermore, grinding out has the disadvantage that the local wall thickness of the shell is greatly reduced.

This means that the currently known method has considerable deficits from a technical and commercial point of view. The grinding process removes material from the inside of the shell wall on one side. This leads to an inhomogeneous shell wall thickness. This has several disadvantages. First of all, the minimum wall thickness can be undercut, which leads to production rejects due to non-compliance with the drawing tolerances. Furthermore, this reduced wall thickness leads to a risk to the launch resistance. The projectile may already disintegrate as it passes through the barrel or it may disintegrate in the target in a way that is not desired.

In order to exclude such scenarios, the projectile shells must be measured. This can be done by ultrasound examination, X-ray examination or similar.

The object of the present invention is to solve the aforementioned problems and disadvantages of the prior art. The proposed method is based on mathematical principles and can be executed by defined automated processes. The process reliability is thereby increased. In a series process, imbalance correction is no longer dependent on the subjective skills of the workers. In addition, the method can be easily integrated into the production process.

In addition, technical disadvantages of the currently existing processes are eliminated. The method according to the invention is based on an equalization of the wall thicknesses. This means that the imbalance is reduced by reducing the non-uniformity of the wall thicknesses. As a result, there is no undesired local reduction in wall thickness, as is the case with the existing processes.

The method according to the invention is particularly, but not exclusively, advantageous for the production of spin projectiles.

The object is solved by the features of claim 1. A method for manufacturing a projectile shell is proposed, wherein the projectile shell comprises a body with a recess. The recess forms the inner contour of the body, which forms an inner wall. The associated outer wall is formed by the outer geometry of the body.

By this embodiment, the body comprises an inner wall and an outer wall, as well as a mouth hole which is connected to the aforementioned recess. The inner wall of the body is thus accessible through the mouth hole.

Since the projectile for the method according to the invention is essentially elongated, the projectile shell comprises a central axis. According to the invention, the imbalance of the projectile shell is determined by measurement before machining. The result of the measured imbalance is used to calculate an axis that is shifted relative to the existing central axis. This modified axis can be shifted parallel to the central axis, swiveled around a common point or a combination of both.

If the body is now rotated around the newly calculated, modified axis, e.g. in a turning machine or grinding machine, and undergoes mechanical machining of the outer contour, the imbalance of the projectile shell is reduced by the uneven wall thickness reduction. Such mechanical processing can be done by machining, for example, but grinding can also constitute such mechanical processing.

The basic idea of this method is based on a shifting and/or tilting of the axis of rotation, which is used for machining the projectile shell. The axis of rotation must be selected in such a way that the imbalance disappears as completely as possible after machining the outer contour.

To clamp the body in a corresponding apparatus with the aim of rotating the body, two new center points must first be calculated. One center point is provided at the tail of the projectile and another at the mouth hole.

Mathematically, these new center points can be calculated from the measured imbalance and the properties of the projectile shell. To finish the projectile shell, it must be pre-machined for usage of the modified axis of rotation. For this purpose, for example, the shell can be machined by a milling process in which the later clamping surfaces with the new center points are created.

After milling process, the projectile shell is clamped with adapted clamping surfaces on a corresponding apparatus for rotary finishing. In this clamping, the outer contour of the projectile shell is subsequently finished.

Thus, the method according to the invention requires the following steps:

measurement of the imbalance;
calculation of the shifting of the center points at the tail and mouth hole;
if necessary, creation of the new clamping surfaces;

mechanical finishing of the outer contour.

Regrinding of the inner contour is completely obsolete in the method according to the invention.

Measurements for imbalance are already sufficiently known from prior art, as they must also be carried out with the conventional method from the prior art.

For the calculation of the shifting of the central axes, the projectile shell or the body of the projectile shell is generally understood as a shell-like, axially symmetrical body. Since the body comprises a recess which represents the inner contour of the body, the body can be understood as the difference between two massive solid bodies.

The first solid body corresponds to the outer contour of the body of the projectile shell and the second solid body corresponds to a body that would fill the inner contour of the body. The inner body corresponds to the volume of the recess of the real body. Mathematically, the projectile shell can be represented as the difference between the first solid body (outer contour) and the second solid body (inner contour).

In particular, properties of the inner body such as mass, inertia, center of gravity and imbalance can be calculated from the known dimensions of the outer body that are to be measured:

$${m}_{i} = {m}_{a} - m$$

$${x}_{{SP}_{i}} = \frac{{x}_{{SP}_{a}} * {m}_{a} - {x}_{SP} * m}{{m}_{i}}$$

$${Θ}_{i} = {Θ}_{a} - Θ$$

Thereby m is to be regarded as the mass, xSP as the position of the center of gravity and ⊖ as the inertia tensor. The indices i and a indicate the affiliation to the inner body and the outer body, respectively. Data without indices refer to the real body of the projectile shell according to the invention.

With the knowledge of the mass, the position of the center of gravity and the inertia tensor of the inner body, its main axes of inertia can be determined. It is irrelevant what the exact shape of the inner body is and what irregularities it comprises. The imbalance of the finished projectile shell disappears completely after post-processing if the axis of rotation of the outer contour coincides with the longitudinal principal axis of inertia of the inner body. Mathematically, this object can be solved exactly. Due to measurement inaccuracies and manufacturing tolerances, a certain residual imbalance may remain, but this remains within the tolerance.

By knowing the position of the center of gravity and the direction of the longitudinal main axis of inertia of the inner body, the center points at the tail and mouth hole of the projectile shell can be determined, which must be used for the finishing of the shell in order to eliminate the imbalance of the projectile shell. With these calculated values for the shifting of the central axis, clamping surfaces are milled at the tail and mouth hole, for example by means of a milling process with corresponding shiftings.

After the off-center clamping surfaces have been arranged on the body of the projectile shell, the shell can be finished on the outer contour. The shell with the clamping surfaces is clamped in a turning machine, for example, and the outer contour is finished mechanically. After this machining, the imbalance of the projectile shell is reduced to a minimum.

The mechanical finishing of the rotating body can be carried out as a machining turning process, for example on a lathe.

The modified axis can be shifted to the central axis by the aforementioned calculation in such a way that both axes comprise a common center point at the mouth hole, for example in the center of the mouth hole, but the modified axis can also be shifted to the central axis in such a way that no common center point is found.

The method is particularly advantageous for projectiles in the medium and large caliber range, as the body of these projectile shells is often made in one piece. However, the body can also be composed and is preferably made of metal.

In a special embodiment, the imbalance of the body can be measured during a rotation of the body. This verifies whether and to what extent the imbalance has been eliminated during reworking.

### BRIEF DESCRIPTION OF DRAWINGS

Further features can be seen in the attached drawings. They show

FIG. 1: cross-section of a projectile shell according to the invention;

FIG. 2: cross-section of a projectile shell with imbalance according to the invention;

FIG. 3: projectile shell clamped for rotation according to the invention.

### DETAILED DESCRIPTION

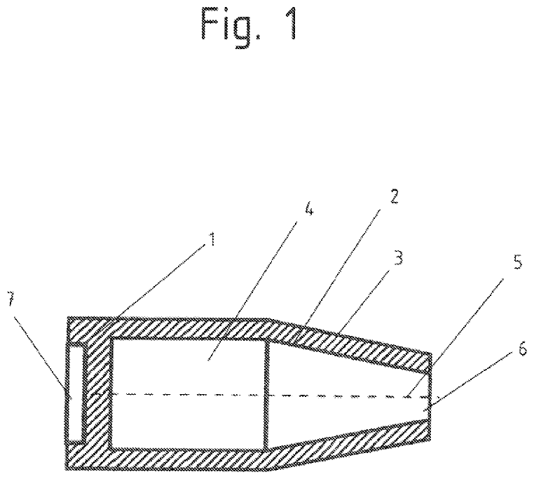

FIG. 1 shows a projectile shell according to the invention, which usually consists of a body 1 made of metal and was manufactured in a forging process. For this purpose, the body 1 comprises an inner wall 2 and an outer wall 3. The inner wall 2 is formed by a recess 4, which comprises a similar geometric shape as the body 1.

The recess 4 creates an inner contour in the body 1, with the inner wall 2 as the boundary in the body 1. Due to the geometry of the body 1, it comprises a central axis 5, which also extends through the recess 4.

The projectile according to the invention further comprises a mouth hole 6 and a tail 7. The tail 7 forms a termination at the bottom of the projectile. The mouth hole 6 is arranged on the opposite side of the tail 7 and provides access to the recess 4.

The recess can be filled through the mouth hole 6, for example, or the projectile can be transported by means of a lifting device attached to the mouth hole.

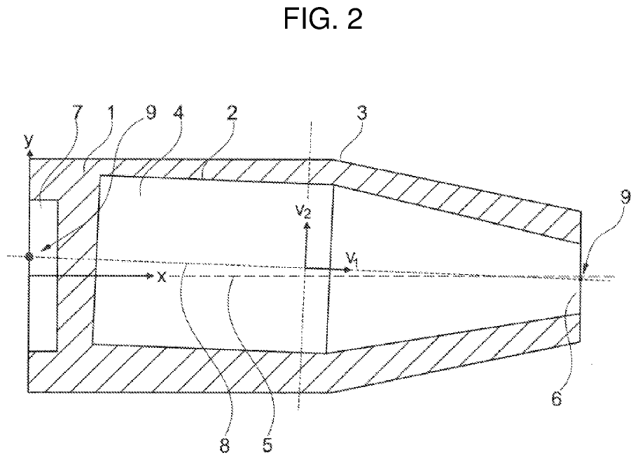

According to the invention, a modified axis 8 is now calculated in FIG. 2. First, an inner body is calculated which corresponds to the volume of the recess 4 and is made of the same material as the body 1. Likewise, an outer body is calculated which corresponds to the geometry of the body 1, but is solid and comprises no recess 4.

Using the real body 1 and the calculated inner and outer bodies, the longitudinal main axis of inertia can now be calculated. To do this, the position of the center of gravity of the inner body is first calculated as well as the associated mass and the associated inertia tensor. The modified axis 8 is then derived from this.

The modified axis 8 is shifted in relation to the central axis 5, which can be seen in FIG. 2 by the offset (v1 and v2). The modified axis 8 is to be considered exemplary and runs differently for each projectile shell depending on the imbalance.

By means of the modified axis 8, center points 9 are calculated at the tail 7 and mouth hole 6, at which a rotation of the projectile shell is carried out. A center point, e.g. at the mouth hole, can also coincide with the center point of the central axis 5.

If the subsequent rotation of the body 1 is to be carried out on a turning machine, a clamping surface must now be created around each of the center points. This is preferably done by a milling process.

The body 1 is then rotated around the modified axis 8 to be machined.

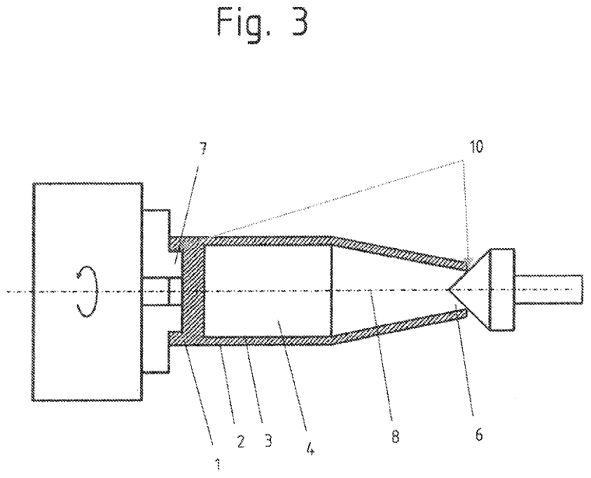

Such a machining operation is shown in FIG. 3. Here the body 1 is clamped in a turning machine by means of the off-center clamping surfaces 10 arranged around the center points. After clamping, the body 1 is rotated around the modified central axis 8 and machined.

Such mechanical processing can be carried out by a machining method, e.g. by means of a turning process or milling process. However, the body 1 can also be machined by grinding or another material-removing method.

After the rotating body has been machined, the imbalance is minimized, at least to the extent that it lies within the specified tolerances. Additional grinding of the inner contour is completely omitted.

The present invention is not limited to the aforementioned features, but further embodiments are conceivable. For example, the body could comprise a different outer and inner contour. The only important thing for the method is that the inner body can be calculated from the known outer geometry and the measured imbalance. Furthermore, the recess can be filled with a penetrator instead of an effective agent. Finally, the imbalance could be measured by a rotation method.

### REFERENCE SIGNS

1 body
2 inner wall
3 outer wall
4 recess
5 central axis
6 mouth hole
7 tail
8 modified axis
9 center points
10 eccentric clamping surfaces

1.-15. (canceled)

16. A method for reducing an imbalance in a projectile shell, with a body which has a recess, whereby the body has an inner wall and an outer wall, with a mouth hole which is connected to the recess, characterized in that a central axis is calculated from the external geometric shape of the projectile shell, that a measurement regarding imbalance of the projectile shell is then carried out, that, based on the imbalance, an axis that is modified in relation to the central axis is then calculated and that based on the calculated modified axis, the body is rotated about the modified axis, wherein the rotating body undergoes mechanical processing.

17. The method according to claim 16, wherein the mechanical processing of the rotating body is carried out as a machining turning process.

18. The method according to claim 16, wherein the body has a tail and that two center points on the tail and mouth hole are calculated by the modified axis.

19. The method according to claim 18, wherein two eccentric clamping surfaces are produced at the tail and the mouth hole, wherein the center points are arranged in the center of the eccentric clamping surfaces.

20. The method according to claim 19, wherein the eccentric clamping surfaces are produced by a milling process.

21. The method according to claim 16, wherein the body is clamped in a turning machine for rotation about the modified axis.

22. The method according to claim 16, wherein the modified axis and the central axis have a common center point in the center of the mouth hole.

23. The method according to claim 16, wherein the projectile shell is embodied as an axially symmetrical body.

24. The method according to claim 16, wherein the body is made in one piece.

25. The method according to claim 16, wherein the body consists of metal.

26. The method according to claim 24, wherein the body is manufactured in a forging process.

27. The method according to claim 16, wherein an inner body is calculated, namely as a solid body from the same material as the body, which corresponds to the volume of the recess.

28. The method according to claim 27, wherein the mass, the position of the center of gravity and the inertia tensor of the inner body are included to calculate the shifted axis.

29. The method according to claim 16, wherein the imbalance is measured while the body is rotating.

30. The method according to claim 16, wherein the projectile shell is used for a spin projectile.
